(19) United States
(12) Patent Application Publication
(10) Pub. No.: US 2008/0149611 A1
(43) Pub. Date: Jun. 26, 2008

(54) Wire feeder packaging and transport system

(76) Inventors: Michael W. Roth, Greenville, WI (US); Michael L. Vanden Heuvel, Sherwood, WI (US)

Correspondence Address: Tait R. Swanson;FLETCHER YODER, P.O. Box 692289, Houston, TX, 77269-2289, US

(21) Appl. No.: 11/644,442

(22) Filed: Dec. 22, 2006

(51) Int. Cl. B23K 9/10; B23K 9/32

(52) U.S. Cl. 219/137.7; 224/645; 219/132; 219/137.71

(57) ABSTRACT

A portable wire feeder system is disclosed that includes a wire feeder disposed in a hands-free carrying case or backpack. The hands-free carrying case or backpack may include a hip mount, a shoulder mount, or a combination thereof. Additionally, the backpack may include a welding torch receptacle. The system may further include a controller configured to exchange data with a welding power supply remotely located from the hands-free carrying case. The system may also include a user control device located on the hands-free carrying case and coupled to the controller. The user control device may also be a wireless communication device and may include a body mount. The system may further include a moisture remover disposed in the backpack and/or a heater.

### BACKGROUND

The invention relates generally to the field of wire feeders and/or welding systems. More specifically, the invention relates to a welding wire feeder.

In certain applications, a welding wire feeder may be used to feed a welding wire through a torch to a molten weld location in front of the tip of the torch. In many applications, it may be desirable to move the wire feeder to a remote location or simply to a different location in a work area. Otherwise, the wire feeder may be required to drive the wire over an unnecessarily long run of conduit to the particular location. As a result, the wire feeder may require a more robust and expensive drive mechanism.

Unfortunately, conventional wire feeders are designed as stationary devices intended to remain within a particular work area. However, some suitcase wire feeders are currently available, and are specifically designed to enable a user to carry the wire feeders to the desired location (i.e., hands-on carrying). Unfortunately, the suitcase wire feeders can be difficult or impossible to carry in areas requiring one or both hands of the user. For example, if the user attempts to move along stairs, ladders, or scaffolding, then the user will generally need to hold a rail or other structure for support and safety.

### BRIEF DESCRIPTION

Embodiments of the present invention enable hands-free transport of a wire feeder enclosed in a carrying case. In certain embodiments, the hands-free carrying case or backpack may include a hip mount, a shoulder mount, or a combination thereof. The system may further include a controller configured to exchange data with a welding power supply remotely located from the hands-free carrying case. The system may include a user control device or a control panel disposed on the hands-free carrying case and coupled to the controller. The user control device may also be a wireless communication device and may include a body mount. For example, a wrist mount, a belt mount, a shirt mount, a collar mount, a neck mount, or a combination thereof. Additionally, the backpack may include a welding torch receptacle. The system may further include a moisture remover disposed in the backpack and/or a heater to facilitate the welding operation in certain environments.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of the portable wire feeder system illustrating the hands-free carrying case positioned on the back of a user;

FIG. 2 is a block diagram illustrating an overview of the portable wire feeder system when used in a remote welding application;

FIG. 3 is a top view of the hands-free carrying case illustrating one possible configuration for the input panel, control panel, and output panel; and

FIG. 4 is a perspective view of the hands-free carrying case or backpack illustrating the remote controls and additional features included in the system.

### DETAILED DESCRIPTION

As discussed in further detail below, various embodiments of a hands-free carrying case with a wire feeder and/or welding component are provided that enable a user to transport the wire feeder and/or welding component to a remote location that may be hundreds of feet away (e.g., away from a power supply). In general, hands free may be defined as both left and right hands being free from the carrying case during transport. Hands-free transport enables a user to safely transport the wire feeder up and down stairs, ladders, and/or scaffolding. In some embodiments, the wire feeder and/or welding components may be entirely or partially disposed within a backpack, a fanny pack or belt mounted luggage, a wrist mounted luggage, a shoulder mounted luggage, or a combination thereof. In other embodiments, one of these luggage types (e.g., backpack) may include another type of welding component with or without the wire feeder, for example, a power supply, a welding gun, a welding controller, a remote control, a welding feedback and monitoring system, and so forth. By further example, the backpack may include a pair of left and right shoulder straps and a hip mount enabling the hands-free transport. The backpack may be back mountable, chest mountable, or both. The backpack may have a soft synthetic shell, a hard synthetic shell, or a combination thereof. The backpack also may have various receptacles, pockets, or holsters for various components, such as a torch, remote control, welding consumables, gauges, and so forth.

The backpack or other hands-free carrying case also may include a moisture remover and/or a heater element facilitating the welding process in cold environments (e.g., −50 Degree Centigrade), humid environments, or both. The system may further include a controller that is coupled to the hands-free case or backpack. The controller may be configured to communicate with the power supply thereby enabling a user to select a welding process or exchange data with the power supply. This may eliminate the need for the user to move back and forth between the weld location and the power supply to adjust a weld setting. The controller may be coupled to a user control device that is independent from the backpack and configured with a body mount to enable quick access to the controller. These features introduced above are now discussed in further detail below with reference to the figures.

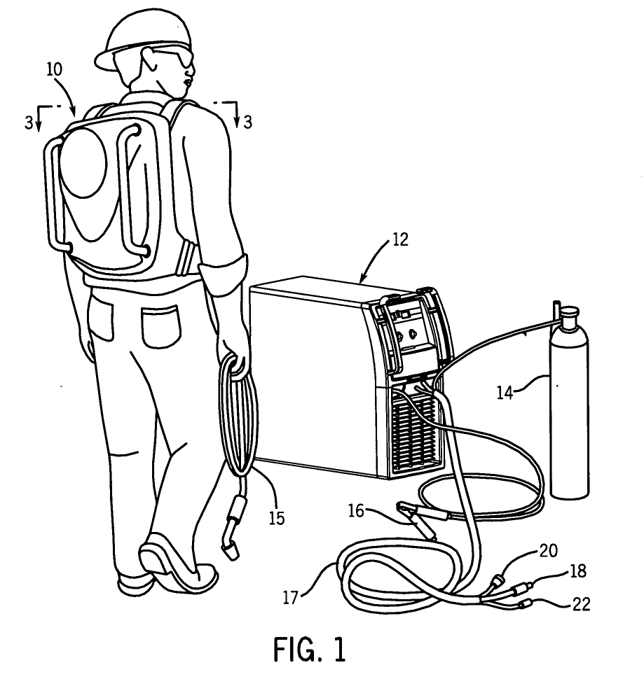

FIG. 1 is a perspective view of a portable wire feeder and/or welding system illustrating an exemplary hands-free carrying case 10 (e.g., backpack) positioned on the back of a user. As noted above, the hands-free carrying case 10 contains or supports one or more wire feeders, welding components, torches, controllers, welding consumables (e.g., contact tips, oxygen tanks, shielding gas tanks, etc.), or a combination thereof. The illustrated system also includes a welding power supply or remote power supply 12 and a gas supply 14. A welding torch 15 is positioned in the user's hand and is configured to couple to the hands-free carrying case 10 to facilitate remote welding, such as Gas Tungsten Arc Welding (TIG), Gas Metal Arc Welding (MIG), Flux Cored Arc Welding (FCAW), or Stick welding. A ground cable/ground clamp 16 is coupled to the power supply 12 and a hose/cable bundle 17 extends from the power supply 12 and gas supply 14. The hose/cable bundle 17 includes a power cable 18, a control line 20, and a gas supply line 22. It should be noted that these cables and lines do not necessarily have to be bundled as illustrated and each cable may not be required for all welding applications. For example, the gas supply line 22 may not be required for certain welding process and/or the power cable 18 may be routed in a different manner.

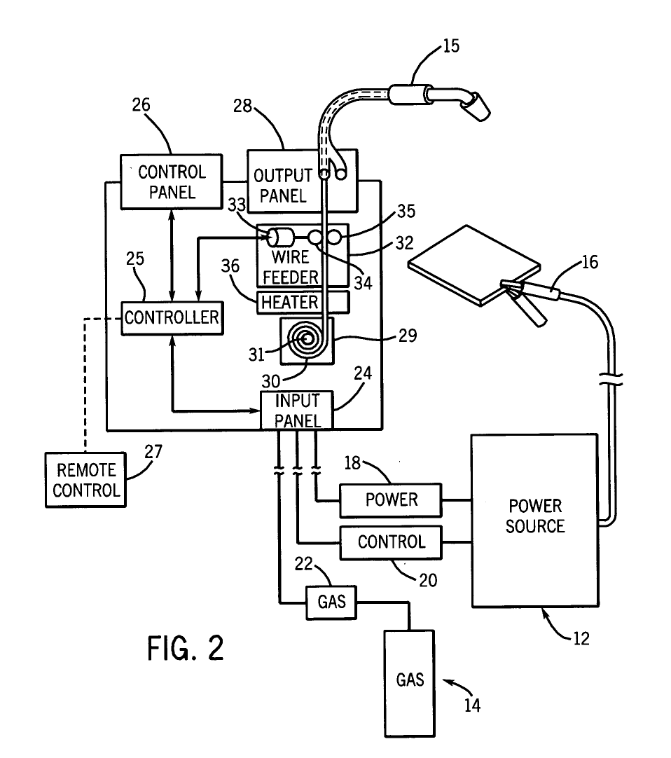

FIG. 2 is a block diagram of the system further illustrating the welding process where the power supply 12 is remotely positioned from a work piece. The ground cable 16 is electrically coupled to the work piece. The power cable 18, the control line 20, and the gas supply line 22 are coupled to the hands-free carrying case 10 via an input panel 24. The input panel 24 is coupled to a controller 25 that is further coupled to a control panel or user control device 26. In some embodiments, the controller 25 also may include a wireless communication device configured to facilitate wireless communication with the power supply 12 and/or a remote control 27. As illustrated, the remote control 27 includes a complementary wireless communication device, such that the control 27 can be moved and operated completely independent and separate from the case 10. In other words, the remote control 27 is not connected to the case 10 by a communication wire, and can be operated at any distance within range of the controller 25. In other embodiments, the remote control 27 may be communicatively and/or mechanically coupled to the case 10 via a cable. In a typical application, the user may be located hundreds of feet from the power supply 12 and gas supply 14. One of the contemplated embodiments enables the user to remotely control the power supply 12 and welding process settings via the controller 25, control panel 26, or remote control 27, or a combination thereof. Advantageously, this remote control aspect may enable the user to remain at the remote welding location without having to travel back and forth between the welding location and power supply 12 to change a weld setting.

The hands-free carrying case 10 further includes an output panel 28 that enables the user to connect the welding torch 15 to the hands-free carrying case 10. The hands-free carrying case 10 includes an electrode wire spool 29 disposed inside the case 10. The spool 29 contains electrode wire 30 and is positioned on a spool support 31 located inside the carrying case 10. The illustrated embodiment includes one spool 29, however, more than one spool may be included enabling the user to select from more than one wire 30 size, type, and so forth. The wire 30 feeds into a wire feeder 32 that drives the weld wire out through the output panel 28 and into the welding torch 15. The wire feeder 32 includes a drive motor or drive 33, a drive roll 34, and a support roll 35. Embodiments of the present invention enclose the wire feeder 32, wire spool 29, and electrode wire 30 in a sealed cavity protecting these welding components from the environment.

Additionally, a moisture removal system may be included in the carrying case 10. The moisture removal system may include a heater 36 or other moisture removal or exclusion techniques. The heater 36 also may be configured to raise the temperature of the wire for a particular application. This may be particularly beneficial for cold environments and/or for high humidity environments. In some embodiments, the case 10 may include temperature and/or humidity sensors coupled to the controller 25, thereby facilitating feedback control of the heater 36. For example, it may be desirable to maintain a particular temperature or humidity level within the case 10, and the feedback sensors may trigger the heater 36 to engage or disengage to maintain a particular environmental state within the case 10. In some embodiments, the case 10 may be airtight, watertight, or both, thereby creating a closed environment within the case 10. A hermetically sealed configuration of the case 10 may facilitate the environmental control within the case 10, while also keeping out moisture, dirt, or other pollutants from corrupting or damaging the wire feeder 32 and other internal components.

Finally, the carrying case 10 may also be used to protect other welding components from the environment in place of, or in addition, to the wire feeder 32 and electrode wire 30. For example, an additional wire feeder, multiple wire spools, welding supplies, welding inspection tools, and portable power supplies are a few welding components that may be disposed in the carrying case 10. Additionally, it should be noted that there are a number of possible locations and orientations of the panel 24, 26, 28 shown in FIG. 2, and this schematic represents one possible location and orientation of the panels.

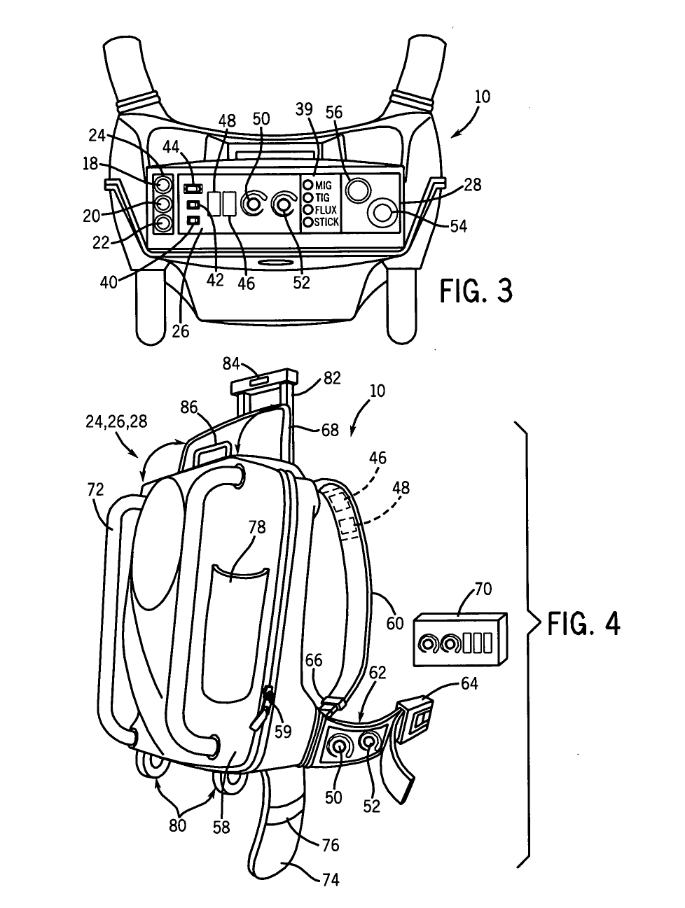

FIG. 3 illustrates one possible configuration for the orientation of the input panel 24, the control panel 26, and the output panel 28 when disposed on the hands-free carrying case 10 (e.g., backpack). As discussed, the input panel 24 includes a connection for the power cable 18, the control line 20, and the gas line 22. The control panel 26 includes a number of user control devices. In general, the control panel 26 may include a variety of knobs, switches, pushbuttons, electrical connectors, analog or digital gauges, analog or digital displays, electrical connectors, or a combination thereof. These various control items on the control panel 26 may correspond to the wire feeder, the torch, the power supply, the gas supply, the heater, or a combination thereof. In addition, all or part of the control panel 26 may be detachable from the case 10. For example, the control panel 26 may snap fit into the case 10, such that it can be removed and operated independent from the case 10. Alternatively, a sub-panel of the control panel 26 and/or the remote control 27 may be detachable to facilitate remote control of the power supply 12, the wire feeder 32, the heater 36, or various other items, or a combination thereof. In the present embodiment, the control panel includes welding process selection control 39, a jog/purge control 40, a trigger hold switch 42, a power control switch 44, a voltmeter 46, a wire speed/amperage meter 48, a wire speed control 50, and a voltage control 52. The welding process selection control 39 enables a user to remotely select and configure the power source for the desired welding operation. For example, the user may select between TIG, MIG, FCAW, or Stick welding. As discussed, the control panel 26 provides a user control device and enables the user to remotely manage the welding parameters.

FIG. 4 is a perspective view of the hands-free carrying case 10 (e.g., backpack 58). The illustrated backpack 58 can be made out of a durable fabric-like material, a fiberglass material, a plastic material (e.g., polypropylene), a metallic material (e.g., aluminum), or a combination thereof. The backpack 58 may include a hinge system or zipper system 59 enabling the user to access the internal cavity of the backpack 58. Additionally, the case 10 may include a pair of left and right shoulder mounts 60 and a hip mount 62. The hip mount 62 may include an adjustable snap 64 and shoulder mount 60 may include an adjustable strap 66 enabling the user to adjust the fit of the backpack 58. The backpack 58 may also include a protective cover 68 for the input panel 24, the control panel 26, and the output panel 28.

Additionally, the shoulder mount 60 and hip mount 62 may include controls and meters similar to those disposed on the control panel 26. For example, the voltmeter 46 and the wire speed/amperage meter 48 may be included on the shoulder mount 60 providing a readily visible display in the situation where the user is wearing the backpack 58. Similarly, the hip mount 62 may include the wire speed control 50 and the voltage control 52 positioned so that these controls are also readily accessible to the user for the same situation discussed above. Other controls may also be included on these or other areas of the backpack 58, thereby enabling the user to quickly access these controls. All of these controls may be coupled to the controller 25 directly via a wired connection or a wireless connection. Moreover, the present embodiment includes a wireless communication device or remote control 70 that enables user control independent of the backpack 58. The communication device 70 may include a user mount that may include a wrist mount, a belt mount, a shirt mount, a collar mount, a neck mount, or a combination thereof. The wireless communication device 70 may communicate with the controller 25, the power welding power supply 12, or a combination thereof. Again, this enables the user access to the controller and enables for immediate adjustment of the weld parameters.

FIG. 4 also illustrates a number of other features incorporated into the backpack 58. The backpack 58 includes skid rails 72 that may be used to support and protect the backpack 58 when it is positioned on the ground. The backpack 58 further includes a welding torch receptacle 74 that includes a pocket 76 for storing the torch, as well as a pocket 78 for storing a remote gas tank. Both of these features enable the user to transport the system, as well as these additional welding components in a hands-free manner. As discussed, this is beneficial when the user is trying to travel along stair cases, scaffolding, or other obstacles encountered at a construction site or other jobsite.

The backpack 58 may also include a set of wheels 80 and a retractable handle 82. The wheels and the retractable handle allow the user to transport the welding system in situations where it is more convenient to roll the system. The distance between the wheels is referred to as the wheel base. One particularly useful aspect of the present embodiment shown is that the wheel base is at least 60% of the width of the backpack. This wide wheel base may prevent the backpack 58 from tipping over during transport by distributing the load to the outer edges of the backpack 58. Retractable handle 82 includes telescope segments that enable the handle to collapse down into a handle housing located in the backpack 58. A button 84 is included on the handle 82 to disengage a locking feature of the handle 82, enabling the user to retract the handle 82. When retracted, the handle 82 reduces the profile of the hands-free carrying case (e.g., backpack 58), thereby reducing the amount of room required for storage or transport. In addition to the retractable handle 82, the backpack 58 may further include a fixed handle 86 or handles (i.e., fixed to the backpack) that may be positioned on opposites sides of the backpack 58. The handles 86 allow the user to lift and transport the welding system in situations where carrying it with hands (i.e., hands-on) is most convenient. Additionally, an across the chest shoulder strap (not illustrated in the figure) may be attached to the backpack 58 to further facilitate transport.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a hands-free carrying case; and
a welding wire feeder disposed in the hands-free carrying case, wherein the welding wire feeder is configured to drive a welding wire.

2. The system of claim 1, wherein the hands-free carrying case comprises a hip mount, a shoulder mount, or a combination thereof.

3. The system of claim 1, wherein the hands-free carrying case comprises a backpack.

4. The system of claim 1, comprising a moisture remover disposed in the hands-free carrying case.

5. The system of claim 1, comprising a heater disposed in the hands-free carrying case.

6. The system of claim 1, comprising a controller coupled to the hands-free carrying case, wherein the controller is configured to exchange data with a welding power supply remote from the hands-free carrying case.

7. The system of claim 6, comprising a wireless communication device coupled to the controller.

8. The system of claim 6, comprising a user control device configured to communicate with the controller, or the welding power supply, or a combination thereof.

9. The system of claim 8, wherein the user control device comprises a control panel disposed on the hands-free carrying case.

10. The system of claim 8, wherein the user control device is independent from the hands-free carrying case.

11. The system of claim 10, wherein the user control device comprises a wireless communication device.

12. The system of claim 11, wherein the user control device comprises a user body mount.

13. The system of claim 12, wherein the user body mount comprises a wrist mount, a belt mount, a shirt mount, a collar mount, a neck mount, or a combination thereof.

14. The system of claim 1, wherein the hands-free carrying case comprises a welding torch receptacle.

15. A system, comprising:
a backpack; and
a wire feeder disposed in the backpack, wherein the wire feeder is configured to feed wire from a spool.

16. The system of claim 15, comprising a control panel coupled to the backpack.

17. The system of claim 16, wherein the control panel comprises welding controls.

18. The system of claim 16, wherein the control panel is detachable from the backpack.

19. The system of claim 15, wherein the backpack is configured to house multiple wire spools.

20. The system of claim 15, comprising another wire feeder disposed in the backpack.

21. The system of claim 20, wherein the wire feeder and the other wire feeder share a common drive.

22. The system of claim 15, comprising a moisture remover disposed in the backpack.

23. The system of claim 15, comprising a remote controller coupled to the backpack, wherein the remote controller is configured to communicate data with the wire feeder, a remote power supply, or a combination thereof.

24. A system, comprising:
a backpack;
a welding component mounted in the backpack; and
a controller coupled to the backpack.

25. The system of claim 24, wherein the welding component comprises a welding wire feeder.

26. The system of claim 24, comprising a remote control configured to communicate with the controller.

27. A system, comprising:
a hands-free carrying case; and
a remote controller coupled to the hands-free carrying case, wherein the remote controller is configured to remotely control a welding power supply, and the remote controller comprises a welding process selection control and a welding parameter control.

28. The system of claim 27, wherein the welding process selection control comprises Gas Tungsten Arc Welding (TIG), Gas Metal Arc Welding (MIG), Flux Cored Arc Welding (FCAW), Stick welding, or a combination thereof.

29. The system of claim 27, wherein welding parameters comprises a jog control, a purge control, a trigger switch, a power control, a wire speed control, a voltage control or a combination thereof.

30. The system of claim 27, wherein the hands-free carrying case comprises a backpack.
